(19) United States
(12) Patent Application Publication
(10) Pub. No.: US 2016/0047681 A1
(43) Pub. Date: Feb. 18, 2016

(54) FLUCTUATION AND PHASE-BASED METHOD FOR DETECTION OF PLUGGED IMPULSE LINES

(71) Applicant: Honeywell International Inc., Morristown, NJ (US)

(72) Inventor: Jian Zhang, Shanghai (CN)

(21) Appl. No.: 14/460,832

(22) Filed: Aug. 15, 2014

(51) Int. Cl. G01F 1/42

(52) U.S. Cl. CPC G01F 1/42

(57) ABSTRACT

A method includes obtaining first and second sets of process variable (PV) measurements generated using a sensor, where the sensor is fluidly coupled to first and second impulse lines. The method also includes identifying fluctuations in the first and second sets of PV measurements. The method further includes identifying a phase difference between the first set of PV measurements and the second set of PV measurements. In addition, the method includes determining whether one or more of the impulse lines are plugged using the fluctuations and the phase difference. Both impulse lines may be plugged when the fluctuations in both sets of PV measurements are at or near zero. Only the first impulse line may be plugged when the fluctuation in the first set of PV measurements is at or near zero. Only the second impulse line may be plugged when the phase difference is at or near zero.

### TECHNICAL FIELD

This disclosure relates generally to measurement systems. More specifically, this disclosure relates to a fluctuation and phase-based method for the detection of plugged impulse lines.

### BACKGROUND

Pressure transmitters are used in a wide variety of applications, such as to measure pressure, fluid level, or flow rate in an industrial process. In some applications, such as high-temperature or low-temperature environments or corrosive processes, one or more long tubes or pipes with small diameters (commonly called “impulse lines”) transmit pressure signals from a process to a pressure transmitter for measurement.

Over time, an impulse line can become plugged, partially or completely blocking a pressure signal from reaching a pressure transmitter. Typical blockages can include solid depositions, wax depositions, hydrate formations, sand plugging, gelling, frozen process liquid plugs, and air or foam pockets. As a specific example, in paper mills, impulse lines in paper pulp sections often become blocked by solid depositions.

The plugging of an impulse line can lead to erroneous pressure measurements and undesired control actions based on the erroneous measurements. For example, a process controller could attempt to modify an industrial process based on the erroneous measurements. This can lead to various detrimental effects, such as poor control of the industrial process, a loss of production, a plant shutdown, or even a safety hazard.

### SUMMARY

This disclosure provides a fluctuation and phase-based method for the detection of plugged impulse lines.

In a first embodiment, a method includes obtaining first and second sets of process variable (PV) measurements generated using a sensor, where the sensor is fluidly coupled to first and second impulse lines. The method also includes identifying fluctuations in the first and second sets of PV measurements. The method further includes identifying a phase difference between the first set of PV measurements and the second set of PV measurements. In addition, the method includes determining whether one or more of the impulse lines are plugged using the fluctuations and the phase difference.

In a second embodiment, an apparatus includes at least one memory configured to store first and second sets of PV measurements generated using a sensor. The apparatus also includes at least one processing device configured to identify fluctuations in the first and second sets of PV measurements and identify a phase difference between the first set of PV measurements and the second set of PV measurements. The at least one processing device is also configured to determine whether one or more of first and second impulse lines fluidly coupled to the sensor are plugged using the fluctuations and the phase difference.

In a third embodiment, a non-transitory computer readable medium embodies a computer program. The computer program includes computer readable program code for obtaining first and second sets of PV measurements generated using a sensor. The computer program also includes computer readable program code for identifying fluctuations in the first and second sets of PV measurements. The computer program further includes computer readable program code for identifying a phase difference between the first set of PV measurements and the second set of PV measurements. In addition, the computer program includes computer readable program code for determining whether one or more of first and second impulse lines fluidly coupled to the sensor are plugged using the fluctuations and the phase difference.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate examples of process variable (PV) sensors that operate using impulse lines according to this disclosure;

FIG. 3 illustrates an example system using at least one PV sensor according to this disclosure; and

FIGS. 4 through 6 illustrate an example fluctuation and phase-based method for detecting plugged impulse lines according to this disclosure.

### DETAILED DESCRIPTION

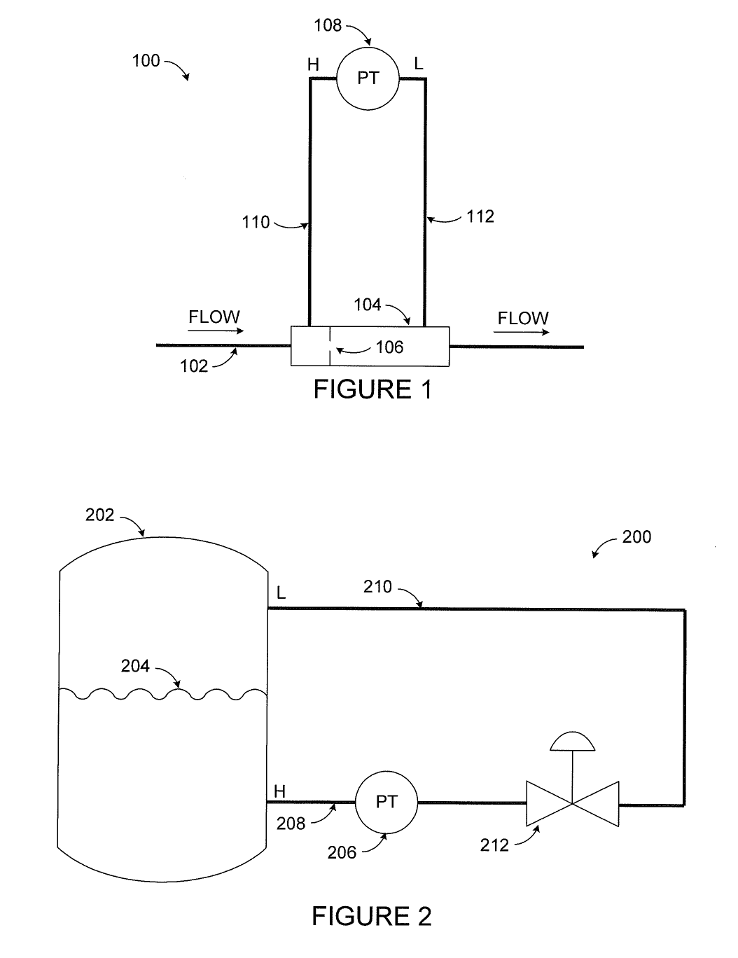

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIGS. 1 and 2 illustrate examples of process variable (PV) sensors that operate using impulse lines according to this disclosure. In particular, FIGS. 1 and 2 illustrate example systems in which pressure sensors that operate using impulse lines can be used. Other types of PV sensors could also be used.

As shown in FIG. 1, a system 100 is used to measure the flow of material through a conduit 102. The conduit 102 represents any suitable tube, pipe, or other structure through which fluid (such as liquid or gas) can flow. A portion 104 of the conduit 102 defines a space in which an orifice 106 is located. The orifice 106 denotes an opening that is smaller than the surrounding portion 104 of the conduit 102 in which the opening is located.

A pressure transmitter 108 is fluidly coupled to two impulse lines 110-112. The impulse lines 110-112 are fluidly coupled to the portion 104 of the conduit 102 on opposite sides of the orifice 106. The impulse lines 110-112 provide pressure signals from the conduit 102 to the pressure transmitter 108. In this example, the impulse line 110 is expected to transmit a higher pressure than the impulse line 112. For this reason, the impulse line 110 is referred to as a “high-side” impulse line, and the impulse line 112 is referred to as a “low-side” impulse line.

Pressure signals within the impulse lines 110-112 are used by the pressure transmitter 108 to generate pressure measurements associated with the conduit 102. The pressure measurements can be used in various ways, such as to identify the flow rate of material through the conduit 102.

Each of the impulse lines 110-112 includes any suitable tube, pipe, or other passage that allows a pressure signal to be provided to a pressure transmitter. Each of the impulse lines 110-112 could be formed from any suitable material(s) and in any suitable manner. Each of the impulse lines 110-112 could also have any suitable dimensions, such as a length of up to 1.8 meters or more.

If either of the impulse lines 110-112 becomes partially or completely plugged, the pressure transmitter 108 cannot accurately measure the pressure in the conduit 102. As a result, the flow rate of material through the conduit 102 may not be accurately measured and used. As explained in greater detail below, the pressure transmitter 108 (or an external component that operates using data from the pressure transmitter 108) can analyze pressure or other PV measurements to identify when one or both impulse lines 110-112 become partially or completely plugged.

As shown in FIG. 2, a system 200 is used to measure the level of material in a tank 202. The tank 202 represents any suitable structure that can hold at least one material 204. The tank 202 could be in a fixed position or portable, such as on a vessel. The material 204 could represent any suitable material(s), such as chemicals, petrochemicals, or water.

A pressure transmitter 206 is fluidly coupled to an impulse line 208, which is fluidly coupled at or near the bottom of the tank 202. The pressure transmitter 206 is also fluidly coupled to an impulse line 210, which is fluidly coupled at or near the top of the tank 202. Pressure signals within the impulse lines 208-210 are used by the pressure transmitter 206 to generate pressure measurements associated with the tank 202.

The pressure measurements can be used in various ways, such as to identify the level of material 204 in the tank 202 and thereby control the loading or unloading of the material 204. For instance, the pressure within the impulse line 210 could represent a reference pressure within the tank 202, and the pressure within the impulse line 208 could be based on the amount of material 204 in the tank 202 (along with the reference pressure). In this example, the impulse line 210 is fluidly coupled to the pressure transmitter 206 via a valve 212, which could allow the pressure transmitter 206 to operate at desired times (such as only during times when material 204 is loaded or unloaded in the tank 202).

Each of the impulse lines 208-210 includes any suitable tube, pipe, or other passage that allows a pressure signal to be provided to a pressure transmitter. Each of the impulse lines 208-210 could be formed from any suitable material(s) and in any suitable manner. Each of the impulse lines 208-210 could also have any suitable dimensions, such as a length of up to 1.8 meters or more.

If either impulse line 208-210 becomes partially or completely plugged, the pressure transmitter 206 cannot accurately measure the level of material 204 in the tank 202. This could lead to material spills, undesirable control actions, or other problems. As explained in greater detail below, the pressure transmitter 206 (or an external component that operates using data from the pressure transmitter 206) can analyze pressure or other PV measurements to identify when one or both impulse lines 208-210 become partially or completely plugged.

Although FIGS. 1 and 2 illustrate several examples of PV sensors that operate using impulse lines, various changes may be made to FIGS. 1 and 2. For example, FIGS. 1 and 2 are merely meant to illustrate different operational environments in which a process variable sensor can be used in conjunction with impulse lines. The technique described below for analyzing PV measurements to identify when one or more impulse lines are plugged could be used with any suitable sensors and in any suitable system.

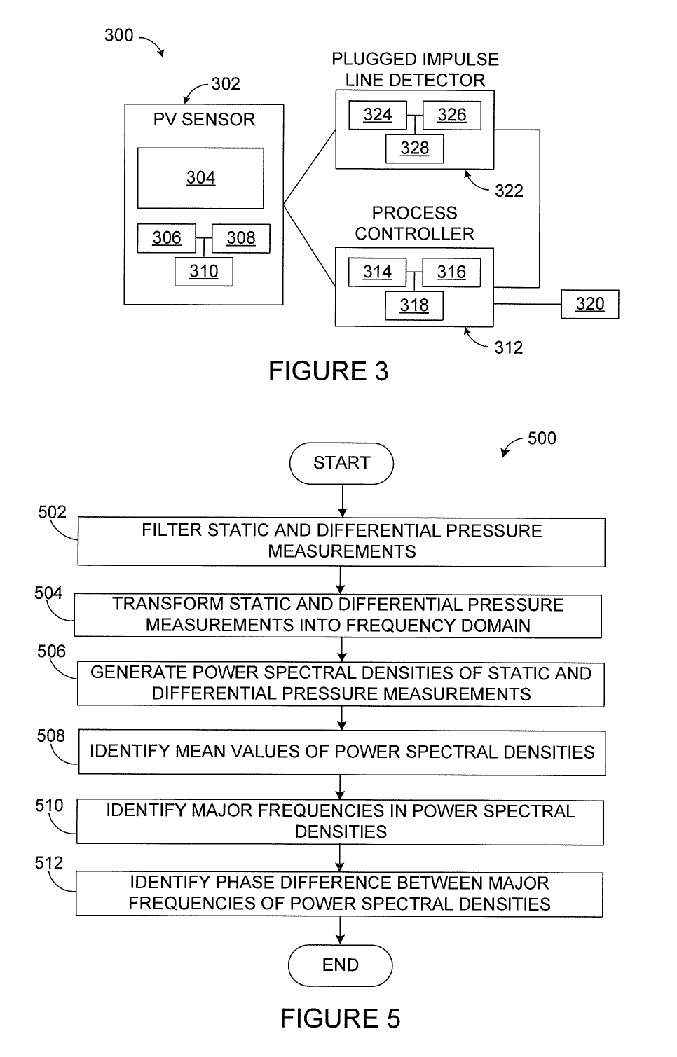

FIG. 3 illustrates an example system 300 using at least one PV sensor 302 according to this disclosure. The PV sensor 302 in FIG. 3 could represent the pressure transmitter 108 of FIG. 1 or the pressure transmitter 206 of FIG. 2. Note, however, that any other suitable PV sensor(s) could be used.

In this example, the PV sensor 302 includes sensing components 304, which generally operate to generate pressure measurements. The sensing components 304 are used to measure both static pressure (SP) and differential pressure (DP) using pressure signals received via multiple impulse lines. A static pressure measurement represents a measurement of a pressure signal received over a single impulse line, such as a high-side impulse line. A differential pressure measurement represents a measurement of the difference between pressure signals received over multiple impulse lines.

The sensing components 304 include any suitable structure(s) for generating SP and DP measurements using multiple impulse lines. In some embodiments, the PV sensor 302 could be implemented using a SMARTLINE ST800 smart pressure transmitter from HONEYWELL INTERNATIONAL INC. The SMARTLINE ST800 pressure transmitter has the ability to generate both static and differential pressure measurements.

The PV sensor 302 in this example also includes at least one processing device 306, at least one memory 308, and at least one interface 310. The processing device 306 could be used to generate and optionally process or analyze pressure measurements. The memory 308 could be used to store instructions and data used, generated, or collected by the processing device 306. The interface 310 supports any suitable communication with external devices or systems over one or more communication links.

The sensor 302 provides pressure or other process variable measurements to one or more external devices or systems. In this example, the sensor 302 provides PV measurements to a process controller 312 and/or a plugged impulse line detector (PILD) 322.

The process controller 312 can use the PV measurements to generate control signals for adjusting one or more characteristics of a process being controlled. For example, the process controller 312 could generate signals for controlling the flow rate of material through the conduit 102 or for controlling the loading/unloading of material 204 in the tank 202. The process controller 312 could be implemented using at least one processing device 314, at least one memory 316, and at least one interface 318. The process controller 312 could also present information (such as PV measurements) to an operator via one or more human machine interfaces (HMIs) 320, such as graphical displays. As described below, the process controller 312 could be configured to analyze the PV measurements from one or more PV sensors 302 and identify when one or more impulse lines fluidly coupled to a sensor 302 are partially or completely plugged. If detected, the process controller 312 could take any suitable corrective action(s), such as generating an alarm (which could be presented on an HMI 320) or scheduling maintenance.

PV measurements could also or alternatively be provided to the PILD 322, either directly or indirectly (such as via the process controller 312). The PILD 322 can analyze the PV measurements from the sensor 302 and identify when one or more impulse lines fluidly coupled to the sensor 302 are partially or completely plugged. If detected, the PILD 322 could take any suitable corrective action(s), such as generating an alarm or scheduling maintenance. The PILD 322 could be implemented using at least one processing device 324, at least one memory 326, and at least one interface 328. The PILD 322 could also analyze data from and identify problems with any number of sensors 302.

Each processing device 306, 314, 324 described above includes any suitable processing or computing device, such as one or more microprocessors, microcontrollers, digital signal processors, field programmable gate arrays, application specific integrated circuits, or discrete logic devices. Each memory 308, 316, 326 described above includes any suitable storage and retrieval device(s), such as a random access memory (RAM) or a Flash or other read-only memory (ROM). Each interface 310, 318, 328 described above includes any suitable structure configured to communicate over at least one communication link, such as a Highway Addressable Remote Transducer (HART) interface, an Ethernet transceiver, or a radio frequency (RF) interface.

Although FIG. 3 illustrates one example of a system 300 using at least one PV sensor 302, various changes may be made to FIG. 3. For example, the functional division shown in FIG. 3 is for illustration only. Various components in FIG. 3 could be combined, further subdivided, or omitted and additional components could be added according to particular needs. As a particular example, the functionality of the PILD 322 could be incorporated into the process controller 312 or into the sensor 302 itself.

As can be seen in FIG. 3, the ability to detect when one or more impulse lines fluidly coupled to a PV sensor are partially or completely plugged can be implemented in a variety of ways. This functionality could be implemented within the PV sensor itself, by a process controller, or by a PILD (which could itself be incorporated into a PV sensor, process controller, or other device). This disclosure is intended to encompass all such possible implementations of this functionality. In particular embodiments, this functionality could be incorporated into the ADI 360 multipoint control unit (MCU) of a SMARTLINE ST800 smart pressure transmitter and configured via the HMI of the SMARTLINE ST800 transmitter.

As noted above, the plugging of an impulse line used by a PV sensor can create various problems, including safety issues in an industrial facility. One conventional approach to dealing with this problem involves performing maintenance on the impulse lines at periodic intervals. However, under this approach, impulse lines that are not plugged could be cleaned, and it is not possible to detect when problems arise between maintenance operations.

This disclosure recognizes that pressure fluctuations in SP and DP values represent noise that propagates from the high-side of a PV sensor to the low-side of the PV sensor. From this viewpoint, frequency analysis can provide an indication about the condition of the impulse lines associated with the PV sensor. In accordance with this disclosure, a fluctuation and phase-based technique for the detection of plugged impulse lines is provided. While this technique is described below as being performed by the PILD 322, the same or similar technique could be performed by a PV sensor, a process controller, or any other suitable device(s). Also, while described as being used in the system 300 of FIG. 3, this technique could be used in any suitable system with any suitable devices.

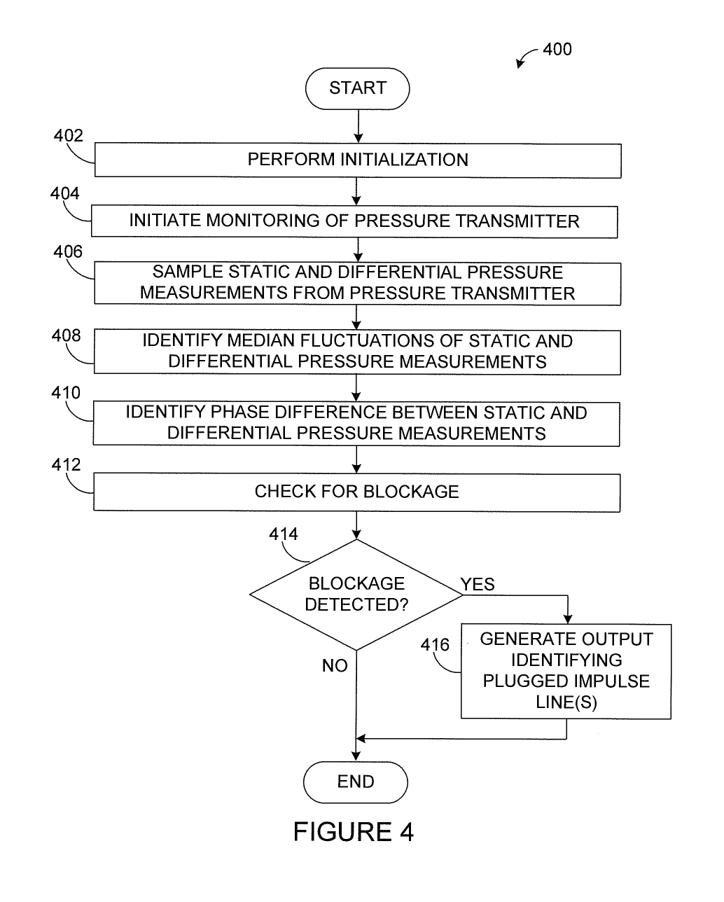

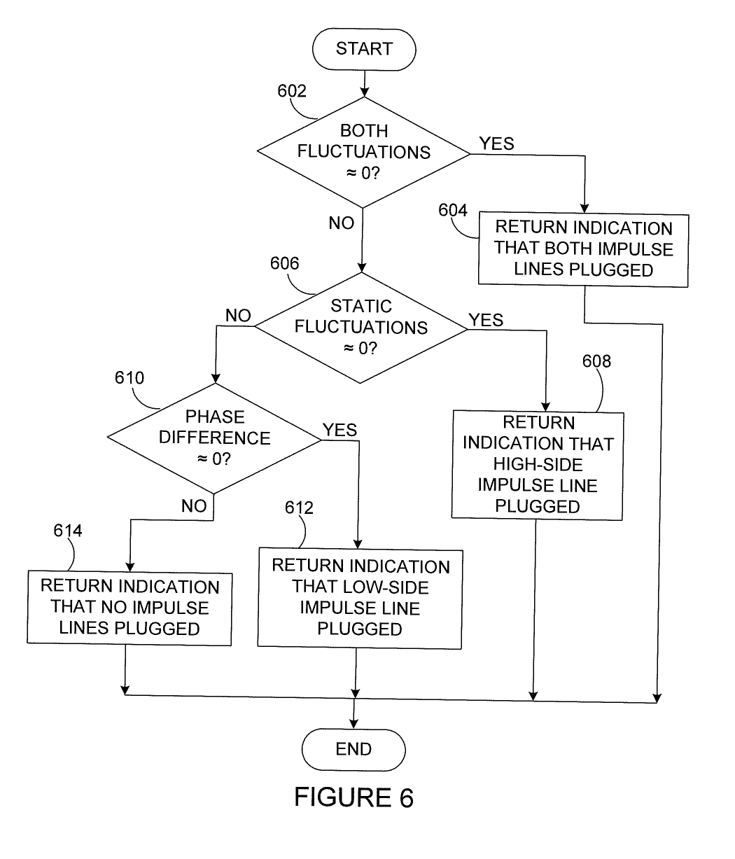

FIGS. 4 through 6 illustrate an example fluctuation and phase-based method for detecting plugged impulse lines according to this disclosure. More specifically, FIG. 4 illustrates an example fluctuation and phase-based method 400 for detecting one or more plugged impulse lines, FIG. 5 illustrates an example method 500 for calculating the phase difference between SP and DP values, and FIG. 6 illustrates an example method 600 for identifying specific blocked impulse lines.

As shown in FIG. 4, an initialization is performed at step 402. This could include, for example, the processing device 324 of the PILD 322 booting up and establishing communications with other devices, such as at least one PV sensor 302. Monitoring of a pressure transmitter is initiated at step 404. This could include, for example, the processing device 324 of the PILD 322 determining that plugged impulse line detection has been enabled for the PV sensor 302.

Static and differential pressure measurements from the PV sensor are sampled at step 406. This could include, for example, the processing device 324 of the PILD 322 identifying the SP and DP measurements output by the PV sensor 302 during a specified sampling window. Any suitable sampling rate could be used to sample the measurements output by the PV sensor 302, including a lower sampling rate (such as 50 Hz or less). Also, any number of sampled measurements can be collected during the sampling window, which could represent any suitable length of time.

Median fluctuations of the static and differential pressure measurements are identified at step 408. This could include, for example, the processing device 324 of the PILD 322 calculating the median fluctuation of the static pressure measurements and the median fluctuation of the differential pressure measurements. In particular embodiments, each median fluctuation is calculated using normalized PV values (denoted F_{Pv}[i]) as follows. In some embodiments, a normalized PV value PV_{NORM}[i] can be defined as:

$${PV}_{NORM} [ i ] = \frac{PV [ i ]}{URL} \qquad ( 1 )$$

where PV[i] denotes the i^{th} process variable measurement and URL denotes the upper range limit of the PV sensor 302. Fluctuations of the normalized PV values indicate (among other things) noise variations in the process variable. In some embodiments, the fluctuations F_{PV}[i] can be defined as:

F_{PV}[i]=|PV_{NORM}[i+1]−PV_{NORM}[i]| (2)

for i=1, 2, . . . , n−1. For an ordered set of fluctuations F_{PV}[1]≦F_{PV}[2]≦ . . . ≦F_{PV}[n], the median fluctuation can be defined as:

$$Median = \{ \begin{matrix}\frac{1}{2} ( {F}_{PV} [ x ] + {F}_{PV} [ x + 1 ] ) , & n = 2 k \\ {F}_{PV} [ x ] , & n = 2 k + 1\end{matrix} \qquad ( 3 )$$

This approach can be used to identify both the median fluctuation of normalized static pressure measurements and the median fluctuation of normalized differential pressure measurements. Note, however, that the use of normalized PV values is not required and that each median fluctuation can be calculated using non-normalized PV values. Moreover, note that the median fluctuation need not be calculated and that some other fluctuation value could be calculated, such as the average static fluctuation and the average differential fluctuation.

A phase difference between the static and differential pressure measurements is identified at step 410. The phase difference generally denotes a time difference between changes in the static pressure measurements and corresponding changes in the differential pressure measurements. The phase difference can be calculated as described below.

A check for blockage in one or more impulse lines occurs at step 412, and a determination is made whether at least one blocked impulse line has been detected at step 414. This could include, for example, the processing device 324 of the PILD 322 using the calculated fluctuations in the static and differential pressure measurements and the phase difference between the static and differential pressure measurements. One example technique for identifying a blocked impulse line using the fluctuations and phase difference is provided below.

If at least one blocked impulse line is detected, an output identifying the blocked impulse line(s) is generated at step 416. This could include, for example, the processing device 324 of the PILD 322 generating an alarm that is displayed on an operator console via an HMI or transmitting a notification to a maintenance system. The alarm, notification, or other output could include an identification of which impulse line or lines associated with the PV sensor 302 are blocked. However, any other suitable output could be generated in response to detecting one or more blocked impulse lines.

As shown in FIG. 5, one technique for calculating the phase difference between static and differential pressure measurements includes filtering the static and differential pressure measurements at step 502. This could include, for example, the processing device 324 of the PILD 322 using a low-pass filter to filter the static and differential pressure measurements. The filtered measurements undergo a transformation into the frequency domain at step 504. This could include, for example, the processing device 324 of the PILD 322 using a fast Fourier transform (FFT) or other transform to convert the filtered static and differential pressure measurements into the frequency domain.

Power spectral densities (PSDs) of the transformed static and differential pressure measurements are generated at step 506. This could include, for example, the processing device 324 of the PILD 322 using any suitable technique to calculate the PSD of the static pressure measurements in the frequency domain and the PSD of the differential pressure measurements in the frequency domain. The power spectral density of a signal generally describes the power contributed to the signal by various frequencies within the signal.

The mean value of each power spectral density is identified at step 508. This could include, for example, the processing device 324 of the PILD 322 calculating the mean value of the PSD for the static pressure measurements and the mean value of the PSD for the differential pressure measurements. Major frequencies in each PSD are identified at step 510. This could include, for example, the processing device 324 of the PILD 322 identifying any frequency in each PSD that is higher than the mean value of that PSD. This generates a set of one or more frequencies identified in the PSD for the static pressure measurements and one or more frequencies identified in the PSD for the differential pressure measurements.

A phase difference between the major frequencies of the power spectral densities is identified at step 512. This could include, for example, the processing device 324 of the PILD 322 identifying a time delay between a major frequency in the static pressure's PSD and a corresponding major frequency in the differential pressure's PSD. If there are multiple major frequencies in each of the PSDs, the phase difference could represent an average of the time delays associated with individual pairs of major frequencies.

As shown in FIG. 6, one technique for identifying specific blocked impulse lines includes determining if the fluctuations for both the static and differential pressure measurements are zero or near zero at step 602. This could include, for example, the processing device 324 of the PILD 322 determining if the median, average or other calculated fluctuations for the SP and DP values are zero or within a threshold amount of zero. If so, both impulse lines associated with the PV sensor are identified as being plugged, and an indication identifying this condition is returned at step 604. The indicator can be used in any suitable manner, such as to trigger an alarm or schedule maintenance.

Otherwise, the process determines if the fluctuations for the static pressure measurements are zero or near zero at step 606. This could include, for example, the processing device 324 of the PILD 322 determining if the median, average or other calculated fluctuation for the SP values is zero or within a threshold amount of zero. If so, the high-side impulse line associated with the PV sensor is identified as being plugged, and an indication identifying this condition is returned at step 608. The indicator can be used in any suitable manner, such as to trigger an alarm or schedule maintenance.

Otherwise, the process determines if the phase difference between the static and differential pressure measurements is zero or near zero at step 610. This could include, for example, the processing device 324 of the PILD 322 determining if the calculated phase difference is zero or within a threshold amount of zero. If so, the low-side impulse line associated with the PV sensor is identified as being plugged, and an indication identifying this condition is returned at step 612. The indicator can be used in any suitable manner, such as to trigger an alarm or schedule maintenance. If not, no impulse lines associated with the PV sensor are identified as being plugged, and an indication identifying this condition is returned at step 614.

Note the assumption here that the static pressure measurements are associated with the high-side impulse line, so a lack of fluctuation in the static pressure measurements is assumed to correspond with a blocked high-side impulse line. Also, because of this assumption, a small phase difference is assumed to indicate a blocked low-side impulse line. However, this need not be the case, and the high-side and low-side impulse lines in steps 608 and 612 could be reversed.

Although FIGS. 4 through 6 illustrate one example of a fluctuation and phase-based method for detecting plugged impulse lines, various changes may be made to FIGS. 4 through 6. For example, various steps in each figure could be combined, moved, or omitted and additional steps could be added according to particular needs. Also, while each figure shows a series of steps, various steps in each figure could overlap, occur in parallel, or occur any number of times. In addition, the thresholds used above could have any suitable value(s) and could be set in any suitable manner.

Among other things, the approach described above does not require the use of a training phase for the PILD. Many conventional systems often require the use of a training phase during a time when no impulse line blockages are present. The approach described above can successfully operate and identify impulse line blockages without training. Also, this approach is more robust for dynamic processes because the phase difference is robust even in the presence of pressure fluctuations. These and other factors can simplify installation and usage of the PILD 322.

Note that while various characteristics are described above as being used to identify plugged impulse lines, additional characteristics could also be used to facilitate the identification of plugged impulse lines. For example, in some circumstances, the temperatures in the impulse lines can be used along with PV measurements to identify any plugged impulse lines. Also note that while the use of pressure measurements are often described, any other suitable PV measurements could be used.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining first and second sets of process variable (PV) measurements generated using a sensor, the sensor fluidly coupled to first and second impulse lines;
identifying fluctuations in the first and second sets of PV measurements;
identifying a phase difference between the first set of PV measurements and the second set of PV measurements; and
determining whether one or more of the impulse lines are plugged using the fluctuations and the phase difference.

2. The method of claim 1, wherein:
the first set of PV measurements comprises static pressure measurements; and
the second set of PV measurements comprises differential pressure measurements.

3. The method of claim 2, wherein the fluctuations comprise:
a first median fluctuation of the static pressure measurements; and
a second median fluctuation of the differential pressure measurements.

4. The method of claim 2, wherein identifying the phase difference comprises:
transforming the static pressure measurements and the differential pressure measurements into the frequency domain;
generating power spectral densities for the static pressure measurements and for the differential pressure measurements in the frequency domain; and
identifying major frequencies of the power spectral densities.

5. The method of claim 4, wherein identifying the major frequencies comprises, for each power spectral density:
determining a mean of the power spectral density; and
identifying any frequencies in the power spectral density higher than the mean.

6. The method of claim 4, wherein the phase difference is based on a time delay between one of the major frequencies in the power spectral density for the static pressure measurements and a corresponding one of the major frequencies in the power spectral density for the differential pressure measurements.

7. The method of claim 1, wherein determining whether one or more of the impulse lines are plugged comprises:
determining that both the first and second impulse lines are plugged when the fluctuations in both the first and second sets of PV measurements are at or near zero;
determining that the first impulse line but not the second impulse line is plugged when the fluctuation in the first set of PV measurements but not the fluctuation in the second set of PV measurements is at or near zero; and
determining that the second impulse line but not the first impulse line is plugged when the phase difference is at or near zero.

8. The method of claim 7, further comprising:
generating at least one of an alarm and a notification in response to determining that one or more of the impulse lines are plugged;
wherein at least one of the alarm and the notification identifies which of the impulse lines is plugged.

9. An apparatus comprising:
at least one memory configured to store first and second sets of process variable (PV) measurements generated using a sensor; and
at least one processing device configured to:
identify fluctuations in the first and second sets of PV measurements;
identify a phase difference between the first set of PV measurements and the second set of PV measurements; and
determine whether one or more of first and second impulse lines fluidly coupled to the sensor are plugged using the fluctuations and the phase difference.

10. The apparatus of claim 9, wherein:
the first set of PV measurements comprises static pressure measurements; and
the second set of PV measurements comprises differential pressure measurements.

11. The apparatus of claim 10, wherein the fluctuations comprise:
a first median fluctuation of the static pressure measurements; and
a second median fluctuation of the differential pressure measurements.

12. The apparatus of claim 10, wherein the at least one processing device is configured to identify the phase difference by:
transforming the static pressure measurements and the differential pressure measurements into the frequency domain;
generating power spectral densities for the static pressure measurements and for the differential pressure measurements in the frequency domain; and
identifying major frequencies of the power spectral densities.

13. The apparatus of claim 12, wherein the at least one processing device is configured to identify the major frequencies by, for each power spectral density:
determining a mean of the power spectral density; and
identifying any frequencies in the power spectral density higher than the mean.

14. The apparatus of claim 12, wherein the phase difference is based on a time delay between one of the major frequencies in the power spectral density for the static pressure measurements and a corresponding one of the major frequencies in the power spectral density for the differential pressure measurements.

15. The apparatus of claim 9, wherein the at least one processing device is configured to determine whether one or more of the impulse lines are plugged by:
determining that both the first and second impulse lines are plugged when the fluctuations in both the first and second sets of PV measurements are at or near zero;
determining that the first impulse line but not the second impulse line is plugged when the fluctuation in the first set of PV measurements but not the fluctuation in the second set of PV measurements is at or near zero; and
determining that the second impulse line but not the first impulse line is plugged when the phase difference is at or near zero.

16. The apparatus of claim 9, wherein:
the at least one processing device is further configured to generate at least one of an alarm and a notification in response to determining that one or more of the impulse lines are plugged; and
at least one of the alarm and the notification identifies which of the impulse lines is plugged.

17. A non-transitory computer readable medium embodying a computer program, the computer program comprising computer readable program code for:
obtaining first and second sets of process variable (PV) measurements generated using a sensor;
identifying fluctuations in the first and second sets of PV measurements;
identifying a phase difference between the first set of PV measurements and the second set of PV measurements; and
determining whether one or more of first and second impulse lines fluidly coupled to the sensor are plugged using the fluctuations and the phase difference.

18. The computer readable medium of claim 17, wherein:
the first set of PV measurements comprises static pressure measurements; and
the second set of PV measurements comprises differential pressure measurements.

19. The computer readable medium of claim 18, wherein the computer readable program code for identifying the phase difference comprises computer readable program code for:
transforming the static pressure measurements and the differential pressure measurements into the frequency domain;
generating power spectral densities for the static pressure measurements and for the differential pressure measurements in the frequency domain;
for each power spectral density, determining a mean of the power spectral density and identifying major frequencies higher than the mean in the power spectral density; and
identifying the phase difference based on a time delay between one of the major frequencies in the power spectral density for the static pressure measurements and a corresponding one of the major frequencies in the power spectral density for the differential pressure measurements.

20. The computer readable medium of claim 17, wherein the computer readable program code for determining whether one or more of the impulse lines are plugged comprises computer readable program code for:
determining that both the first and second impulse lines are plugged when the fluctuations in both the first and second sets of PV measurements are at or near zero;
determining that the first impulse line but not the second impulse line is plugged when the fluctuation in the first set of PV measurements but not the fluctuation in the second set of PV measurements is at or near zero; and
determining that the second impulse line but not the first impulse line is plugged when the phase difference is at or near zero.
